(19) United States
(12) Patent Application Publication
(10) Pub. No.: US 2008/0218380 A1
(43) Pub. Date: Sep. 11, 2008

(54) Distributed Intelligence For Traffic Signal Control

(76) Inventors: Richard Wayne Wall, Moscow, ID (US); Andrew Parris Huska, Post Falls, ID (US)

Correspondence Address: KLARQUIST SPARKMAN, LLP, 121 SW SALMON STREET, SUITE 1600, PORTLAND, OR, 97204, US

(21) Appl. No.: 11/995,103

(22) PCT Filed: Jul. 7, 2006
(86) PCT No.: PCT/US2006/026797

§ 371 Date: Jan. 8, 2008

Related U.S. Application Data
(60) Provisional application No. 60/697,662, filed on Jul. 8, 2005.

(51) Int. Cl. G08G 1/095

(52) U.S. Cl. 340/907

(57) ABSTRACT

Intelligent traffic control devices that are spatially distributed at strategic locations on streets, highways, and intersections communicate bi-directional complex information to control the movement of various users in a safe and efficient manner. The intelligence of the traffic control devices is based on the capability of each device to operate in manners normally associated with computer-based controls. Such actions include the ability to react to complex instructions, perform logical and arithmetical computations, make records of sequences of events, perform self-diagnostic assessments, take reliable and predictable autonomous actions, and communicate information collected from environmental sensors or internal state of operation. Such devices may contain varying degrees of binary coded descriptions that describe device capability and performance characteristics to other traffic control devices that may require access to sensory information and/or control functions.

### CROSS REFERENCE TO RELATED APPLICATION

This application claims priority to U.S. Provisional Patent Application 60/697,662, filed Jul. 8, 2005, and that is incorporated herein by reference.

### ACKNOWLEDGMENT OF GOVERNMENT SUPPORT

This invention was made with Government support under Contract No. DTRS98-G-0027, awarded by the U.S. Department of Transportation, Research and Innovative Technology Administration. The government has certain rights in the invention.

### FIELD

The disclosure pertains to traffic control networks and devices.

### BACKGROUND

Modern intersection traffic controllers have considerable computational power but are constrained to simple binary inputs and outputs. Typical signalized intersections require the installation of several hundred dedicated conductors to each traffic signal head, pedestrian indication, pedestrian button, loop detector, and other auxiliary devices. Each of these conductors can deliver high voltage or no voltage, by which a lamp can be turned on or off or a sensor can indicate being active or inactive. Since traffic controller inputs and outputs are constrained to either on or off, it is impossible to communicate complex information.

Traffic control systems also tend to be “ad-hoc,” with any particular configuration established based on a specific traffic configuration, with little capability for reconfiguration. As a result, traffic management systems tend to be expensive to expand or reconfigure to adapt to new traffic or road conditions, and often fail to do more than provide a limited, local solution to particular traffic problems. As a particular example of such limitations, pedestrian signals have been developed that include count-down timer displays that are intended to display a time remaining in which a pedestrian crossing can be made safely. While drop-in replacements for conventional pedestrian signals without countdown timers can be made, newly installed countdown pedestrian signals must “learn” when to initiate the countdown sequence by observing the adjacent green phase interval. Thus, any changes due to time-of-day signal timing, or associated with manually actuated signals result in an inaccurate countdown, potentially endangering pedestrians.

In view of the preceding, improved methods and apparatus for traffic management and control are needed.

### SUMMARY

A traffic control device comprises a memory configured to store computer-executable instructions that generate specific control outputs or information configured for delivery to other traffic control devices. The memory can be configured to store descriptions of input/output characteristics of one or more traffic control devices and device communication characteristics. In some examples, the memory is configured to store an electronic description of the traffic control device as well as operational parameters and status for one or more traffic control devices based upon values communicated to the traffic control device or sensed by the traffic control device.

Traffic control device interfaces comprise a memory configured to store a device definition, and a processor configured to communicate at least a portion of the device definition to an interface output. In some examples, the device definition includes a device description. In other examples, the device definition is associated with available displays for color field of a traffic signal or other device characteristic or capability. In some examples, the available displays include at least two display patterns for at least one of a red, green, or yellow traffic signal color field. In additional examples, the device definition is associated with a duration of a count down interval for a pedestrian count down timer. In other examples, the device definition is associated with an availability of an audible count down. In still further examples, the device definition is associated with count down time remaining for the pedestrian count down timer during a current count down. According to some examples, the device definition is associated with a traffic count and a traffic count time interval for a traffic detector. In a particular example, the device definition is further associated with a vehicle type count.

A traffic apparatus comprises a memory configured to retain a traffic control device electronic definition, an output configured to communicate at least a portion of the electronic definition, and a traffic control device configured to process instructions based on the electronic definition. In some examples, the traffic control device is a traffic signal, and the electronic definition is associated with a plurality of display arrangements. In other examples, the traffic control device is a traffic signal having red, green, and yellow color fields, and the electronic definition is associated with display of a solid color or an arrow in selected color fields. In still additional examples, the traffic control device is a traffic detector, and the electronic definition is associated with activation of the traffic detector and a count of vehicles detected in a predetermined time period. In other examples, the traffic control device is a count down timer, and the electronic definition includes a count down period duration. In further embodiments, the electronic definition includes an indication of an audible alarm availability.

Traffic control systems comprise a plurality of traffic control devices, a traffic system controller, and a network connecting the traffic control devices and the traffic system controller. The traffic system controller and the traffic control devices are configured to exchange multi-bit traffic control parameters via the network. In some examples, the traffic control systems are configured to communicate a count down timer duration via the network. In other examples, the traffic system controller is configured to transmit an instruction via the network that is associated with display of a particular pattern in a selected traffic signal color field.

Traffic control methods comprise providing a plurality of traffic control devices and selecting an operational state of at least one traffic control device by communicating a multi-bit command to the at least one traffic control device. In some examples, the methods also include interrogating at least one traffic control device to determine a current status, and sending a traffic control device instruction to at least a second traffic control device based on the interrogation. In further examples, the current status of the at least one traffic control device is an available time for crossing an intersection, and the traffic control device instruction is associated with a count down timer count duration.

Traffic signals are provided that comprise red, green, and yellow color fields. At least one of the color fields is configured to selectively display a solid circular color pattern and an arrow. In some examples, each color field is configured to display a solid circular pattern and an arrow or other pattern. In some examples, the traffic signal comprises an input configured to receive an instruction associated with color field display. In other examples the traffic signal includes an output configured to communicate a currently selected color field pattern selection, or a sequence of such pattern selections. In additional examples, the traffic signal includes a memory and a processor, wherein the processor is configured to store or recall traffic signal characteristics from the memory, and couple representations of such characteristics between the input and the memory and/or the output and the memory.

Traffic control devices comprise a bi-directional communication port configured for communication over a traffic control network, a traffic transducer, and a processor coupled to the traffic transducer and to the bi-directional communication port. In come examples, the traffic transducer is a signal device or a sensor device. The traffic control devices can also include a memory configured to store a series of computer executable instructions for the processor. In other examples, the processor is configured to establish a traffic transducer operating condition based on an input received via the bi-directional communication port. In further representative examples, the processor is configured to establish a safe-fail operating condition for the traffic transducer in response to an absence of communication received on the bi-directional communication port.

The foregoing and other objects, features, and advantages will become more apparent from the following detailed description, which proceeds with reference to the accompanying drawings.

### BRIEF DESCRIPTION OF THE DRAWINGS

FIG. 1 is a block diagram of a representative intelligent traffic interface module.

FIG. 2 is a block diagram of a representative four-approach intersection that is equipped with intelligent traffic control devices.

FIG. 3 illustrates a programmable three-lens traffic signal that includes arrays of light emitters for red, yellow, and green color fields.

FIGS. 4-5 illustrate representative displays produced by the traffic signal of FIG. 3.

FIG. 6 illustrates a user interface configured for control of one or more traffic control devices based on one or more electronic data sheets.

FIG. 7 illustrates a representative traffic system based on a plurality of traffic control devices having electronic data sheets.

FIG. 8 is a block diagram illustrating certain features of a traffic control device having an electronic data sheet.

FIG. 9 is a block diagram illustrating a representative traffic control device.

### DETAILED DESCRIPTION

As used in this application and in the claims, the singular forms “a,” “an,” and “the” include the plural forms unless the context clearly dictates otherwise. Additionally, the term “includes” means “comprises.” Further, the term “coupled” means electrically or electromagnetically coupled or linked and does not exclude the presence of intermediate elements between the coupled items.

The described systems, apparatus, and methods described herein should not be construed as limiting in any way. Instead, the present disclosure is directed toward all novel and non-obvious features and aspects of the various disclosed embodiments, alone and in various combinations and sub-combinations with one another. The disclosed systems, methods, and apparatus are not limited to any specific aspect or feature or combinations thereof, nor do the disclosed systems, methods, and apparatus require that any one or more specific advantages be present or problems be solved.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatus can be used in conjunction with other systems, methods, and apparatus. Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art.

Intelligent traffic networks and associated devices and methods are described in several representative examples. The described examples take advantage of the IEEE-1451 standard for smart transducer interfaces that describes a variety of network-independent communication interfaces for connecting transducers (sensors or actuators) to microprocessors, instrumentation systems, and control/field networks. According to IEEE-1451, a memory device attached to a transducer/actuator stores a transducer electronic data sheet (“TEDS”) that includes identification, calibration, correction data, measurement range, manufacture-related information, and other information. The IEEE-1451 standard also provides a digital transducer independent interface (TII) for connecting transducers to microprocessors, a transducer bus interface module (TBIM) for connection of multiple physically separated transducers in a multidrop configuration, and a standard interface for mixed-signals for transducer self-identification, control, and an analog signal mode for operational purposes. Wireless communications is also provided. IEEE-1451 is convenient due to its availability as a standard, but other sensor/actuator interfaces and protocols can be used, or custom configurations can be used.

In some representative disclosed examples, Ethernet communications are used to connect a traffic controller to nodes such as, for example, one or more traffic signals or count down pedestrian signals. TEDS are provided for each of the nodes for convenient network installation. In other examples, communications can be based on serial, parallel, Ethernet, Universal Serial Bus (USB), Firewire, wireless, or other communication standards. Physical implementations can use CAT5 cables, ribbon cables, power lines, wireless, or other connections.

A controller such as a laptop, desktop, handheld, or other computer system can be used to control the operation of the nodes based on computer implemented traffic control methods stored in a computer readable medium such as, for example, a disk drive, RAM, ROM, CD, DVD, or other storage media. Alternatively, computer implemented control methods can be implemented using computer executable instructions received from a network connection, such as, for example, a local or wide area network connection such as, for example, an Internet connection. Such control methods can dynamically control traffic based on current or anticipated conditions (traffic, weather, date, time, local events, road conditions, accidents, etc.) as well as perform network diagnostics to confirm that nodes are operating and remaining in communication with a network controller.

The disclosed examples generally pertain to distributed sensor traffic control networks that can include intelligence at all intersection components such as signal heads, pedestrian interfaces, and vehicle detectors. For example, a pedestrian signal can include a microprocessor or multiple microprocessors configured to permit bi-directional communication with a traffic controller or other network devices and nodes, and exchange complex information. In contrast, conventional traffic device are limited to communicating “on” and “off” signals. In a particular example, a loop detector is configured to communicate a number and type of vehicles passing through an intersection in a predetermined time period, such as, for example, a last n seconds. This information can be communicated to, for example, a traffic signal head so that signal timing can be changed to accommodate actual traffic patterns and conditions.

Sensor configurations that permit simple traffic device installation and removal are particularly convenient. For example, a representative vehicle detector or other traffic sensor or control device can be configured to communicate an alert to a network controller upon installation, so that the network controller can query the vehicle detector to establish a detector description that includes device type, manufacturer, default sampling interval, and other vehicle detector-specific characteristics. Hot-swappable devices permit device installation while the traffic network maintains a current operating condition. Devices that permit hot-swappable installation can be especially convenient in high traffic areas, but in other examples, device installation can require powering some network nodes or devices down, and manually reconfiguring the network. In other examples, traffic device installation and configuration can require either local or remote network technician assistance.

In some examples, adaptability and functionality of traffic controllers can be increased with a reduction in physical size of the controller cabinet and the numbers of wires needed to connect signals and sensors. Providing interconnections based on computer communication interfaces generally permits communication of complex data with a simple wireless or wired connection, and bulky, multi-conductor connections are not required.

Intelligent traffic control devices can distribute a wide range of network and traffic data. For example, in contrast to conventional pedestrian and vehicle detectors that merely note the presence of a pedestrian or a vehicle, intelligent sensors can provide data about numbers, types, speeds of vehicles arriving or departing an intersection, numbers of pedestrians, pedestrian crossing time, pedestrian location as a function of time during crossing, as well as identify and provide similar types of information concerning bicyclists and motorcyclists. With the availability of such information, traffic control devices can be dynamically reconfigured in response to complex traffic patterns and increase both the safety and effectiveness of an intersection.

Reliable operation of traffic control systems is of utmost concern and requires reliability of both hardware and software associated with information exchange. Dependable information exchange for failsafe operation and an independent conflict monitoring system are desirable. A particular network can be selected based on anticipated numbers of messages to be transmitted, the size of messages, and the number of network nodes. Physical distances in the network, robustness against environmental interferences, fail-safe operation of the network, and network security are also generally important in traffic control systems, and network interconnections should be selected accordingly.

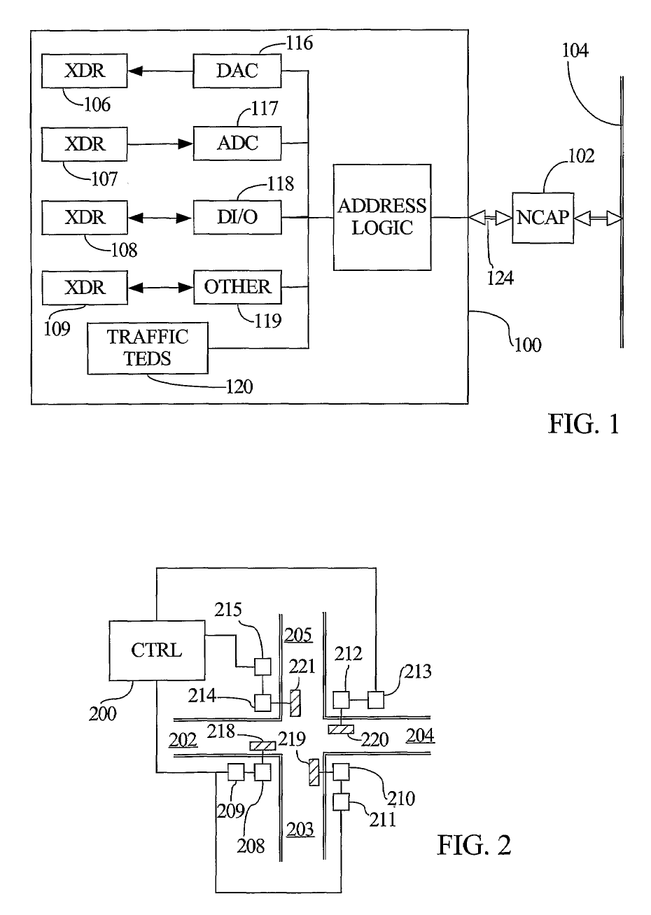

FIG. 1 is a block diagram of a representative smart traffic interface module (STIM) 100 that is in communication with a traffic control network 104. A network capable application processor (NCAP) 102 couples the STIM 100 to the traffic control network 104 using a TII 124. The STIM 100 includes transducers (XDR) 106-109 that are coupled to a digital-to-analog converter (DAC) 116, an analog-to-digital converter (ADC) 117, a digital input/output device (DI/O) 118, or other transducer interface 119, respectively. Traffic device characteristics are stored in a memory 120 that contains a traffic TEDS. Although only four transducers are illustrated in FIG. 1, more or fewer can be provided, as needed. For systems based on the IEEE-1451 standard, a single traffic controller device may provide for as many as 255 sensors and or actuators to accomplish one or more control or instrumentation functions. Additional traffic control devices are generally connected to the network 104 with corresponding NCAPs.

A representative arrangement of traffic device characteristics that can be stored, for example, in the traffic TEDS 120, is shown in the accompanying table of electronic data sheet assignments. In this example, four data bytes are allocated. Data byte 4 is configured to provide information concerning whether a device is a traffic signal head, and, if so, what the capabilities of the device are. For example, a value of 0x00 indicates that the device does not have traffic signal functionality, while a value of 0x04 indicates that the device can provide red, yellow, and green (R/Y/G) indications as solid color balls, and R/Y/G arrows in left, right, and straight ahead directions.

Data bytes 1, 2, and 3 are configured to provide information concerning traffic detectors, pedestrian buttons, and pedestrian signal heads, respectively. A byte code of 0x00 indicates that the device does not have the functionality assigned to the data byte, while other values indicate the type of functionality. For example, a pedestrian signal head can have walk/wait indications only (0x01) or walk/wait and countdown timer indications (0x02). Characteristics of other devices can be similarly identified using the same or additional data bytes. For example, bicycle detectors, video camera monitors, devices enhanced for visually impaired users, or other types of devices or device functionalities can be identified.

Example Electronic Data Sheet Assignments

| | Data byte 4 | Data byte 3 | Data byte 2 | Data byte 1 |
|---|---|---|---|---|
| Byte | (traffic signal | (pedestrian | (pedestrian | (traffic |
| Code | head) | signal head) | button) | detector) |
| 0x00 | No traffic signal | No pedestrian | No pedestrian | No traffic |
| | channel. | signal heads | button | detector |
| | | attached | channels. | channels. |
| 0x01 | R/Y/G ball | Walk and | Button with | “Present/not |
| | indications | wait | reset | present” |
| | | indications | capability | vehicle |
| | | | | detector |
| 0x02 | Red, yellow, and | Walk, wait, | Button with | Number of |
| | green indications | and | user feedback, | vehicles |
| | with balls and | countdown | set and reset | detected |
| | arrow in left | timer | capability | |
| | direction | indications | | |
| 0x03 | R/Y/G indications | Walk, wait, | n/a | Number and |
| | with balls and | and | | type of |
| | arrows in left and | countdown | | vehicles |
| | right directions | timer with | | detected |
| | | visible and | | |
| | | audible | | |
| | | indications | | |
| 0x04 | R/Y/G indications | n/a | n/a | n/a |
| | with balls and | | | |
| | arrows in left, | | | |
| | right, and ahead | | | |
| | directions | | | |

The STIM 100 can be associated with numerous traffic devices and combinations of devices using the appropriate combinations of byte codes for the four data bytes, or additional data bytes can be provided.

While an industry standard electronic description of traffic devices would be desirable, the representative STIM 100 and the electronic descriptions of that above table can be conveniently based on an IEEE-1451 standard sensor definition modified to include a human-readable string (part of a so-called MetaID TEDS) that indicates that a device is a smart traffic control device. For convenience, this smart traffic control device string is stored in the IEEE-1451 “manufacturer identification” field. In addition, a high-level description of STIM channels can be stored in the “model number” field of the MetaID TEDS as shown in the above table of example electronic data sheet assignments. The traffic TEDS 120 can also include channel-specific information for the channels associated with the transducers 106-109.

One example of intelligent traffic control is configured for a four approach intersection illustrated schematically in FIG. 2. The intersection includes approaches 202-205 that are each provided with respective three color traffic signals 209, 211, 213, 215, vehicle detectors 218-221, and pedestrian walk/wait signs on both sides of each approach and pedestrian call buttons on both sides of each approach, indicated schematically as 208, 210, 212, 214. Pedestrian countdown timers can be provided on both sides of the approaches 202-205. These devices are all in communication with a traffic controller 200. As shown in FIG. 2, the devices can be directly coupled to the controller 200, or coupled to the controller via one or more other traffic control devices. Some or all of these devices can be configured for bi-directional communication, and the controller 200 can be in communication with additional controllers, a central traffic network control node, or available over a wide area network (WAN) or other network.

Referring to FIG. 2, a representative intelligent traffic control system for a single intersection operates as follows. The intersection initially has red balls for traffic arrival in four directions and wait signs for all pedestrian crossings. Thus, vehicles and pedestrians are instructed to stop, regardless of their arrival direction. In a steady state, green balls, red left-arrows, red pedestrian wait lights, and pedestrian timers displaying “0” are established for approaches 202, 204. Thus, traffic is permitted through on approaches 202, 204, and pedestrian crossing of approaches 202, 204 is prohibited. Red balls, green pedestrian walk lights, and blank pedestrian timers are displayed at approaches 203, 205. Thus, pedestrians are permitted to cross the approaches 203, 205, while vehicles are stopped. Vehicle detectors for approaches 203, 205 and call buttons for crossing approaches 202, 204 are active.

When a pedestrian button associated with crossing approaches 202, 204 is pushed or a vehicle is detected in either or both of approaches 203, 205, a new phase begins. The pedestrian timers at approaches 203, 205 begin to count down from, for example, nine to zero, at which time pedestrian signals for crossing approaches 203, 205 change from “walk” to “wait.” Approximately five seconds after the this countdown begins, the traffic signals for approaches 202, 204 display yellow balls and red left-arrows, and after a few seconds more they display red balls. As a result, vehicles are prohibited from crossing the intersection from approaches 202, 204. After a one second all-hold period, a ten second period is indicated on count down timers associated with crossing the approaches 202, 204, the correspond “wait” lights become “walk” lights. In addition, vehicles in approaches 203, 205 are provided a ten second period to cross the intersection. Different time intervals can be used as convenient, and the count down timers can be provided with actual time intervals and “learning” is not required. At the end of this period, the intersection signals return to steady state operation.

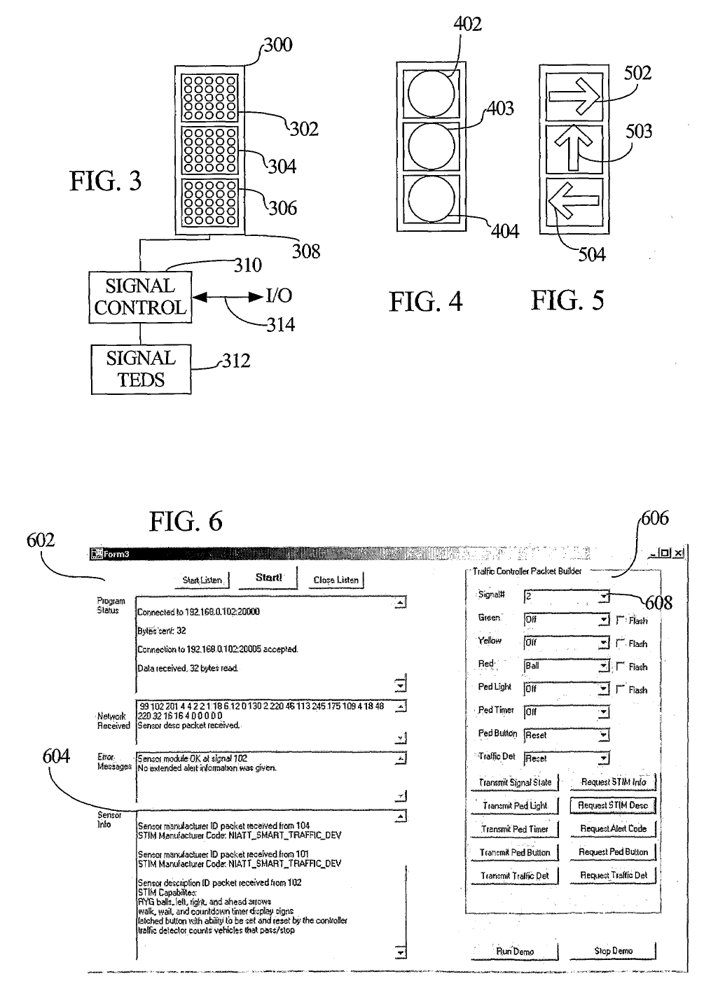

A representative three color traffic signal 300 that includes a memory 312 (typically a non volatile memory 312 such a flash memory) configured to store a traffic signal TEDS or other device descriptor is illustrated in FIG. 3. The traffic signal 300 includes red, yellow, and green display regions 302, 303, 304, respectively. Each of the display regions includes a five by five array of LEDs (such as a representative LED 308) configured so that LEDs can be activated individually or in groups so as to be on, off, dimmed, flashing, or display a predetermined pattern that can be realized by selecting suitable LEDs. A signal controller 310 is coupled to the traffic signal 300, and is configured to provide electrical signals to the LEDs in response to instructions received from a network controller or other network node via an input/output port 314. The signal controller 310 is also coupled for access to the TEDS. The memory 312 can a removable memory chip that is separate from sensor control hardware. The contents of this memory chip describe both the hardware that it is connected to and the hardware capabilities.

Because the display regions of the traffic signal 300 are defined as arrays of LEDs, the display regions can be activated to display circular appearing color balls 402, 403, 404 similar to the color regions and colors produced by conventional traffic signals as shown in FIG. 4. In addition, each color region can be independently configured to display a variety of other patterns associated with forward, reverse, left, and right arrows, other symbols, text, or numbers such as representative arrows 502, 503, 504 illustrated in FIG. 5. As such, the signal controller 310 is responsive to multi-bit and multi-word instructions that are associated with selection of the colors and/or patterns to be displayed.

Intersection control using the arrangement of FIG. 2 can readily adapted to a variety of control situations using, for example, the traffic signal of FIG. 3. Each traffic signal of FIG. 2 can be configured to flash or remain on, display a particular pattern or series of patterns, and can report its state to a network control node as needed. The vehicle detectors can be reset, disabled, and polled for vehicle counts, including vehicle numbers, vehicle types, and count intervals, in response to instructions communicated over the network. In some examples, vehicle lane position can be detected as well. Pedestrian walk/wait lights can be directly programmed with a start-time so the associated countdown timers do not need to “learn” the proper walk times. The pedestrian button latches the street crossing event when the button is pressed, and can be set, reset, polled, or disabled by the controller.

FIG. 6 further illustrates capabilities of networked, intelligent traffic control devices. A portion 604 of a user interface 602 provides access to traffic device TEDS definitions such as device kind and capabilities. As shown in FIG. 6, the user interface is in communication with a vehicle signal, a pedestrian signal, a countdown timer, and a traffic detector. A portion 606 of the user interface 602 is configured for selection of traffic control device parameters. For example, a traffic signal color can be selected to display a particular color or pattern, to flash or to remain on continuously, or otherwise establish device function. In addition, device status can be obtained by interrogating the device, and different devices can be selected for interrogation or instruction based on a device input region 608. In typical installed examples, the parameters set or retrieved using the user interface of FIG. 6 are communicated among devices as needed, and are generally not displayed.

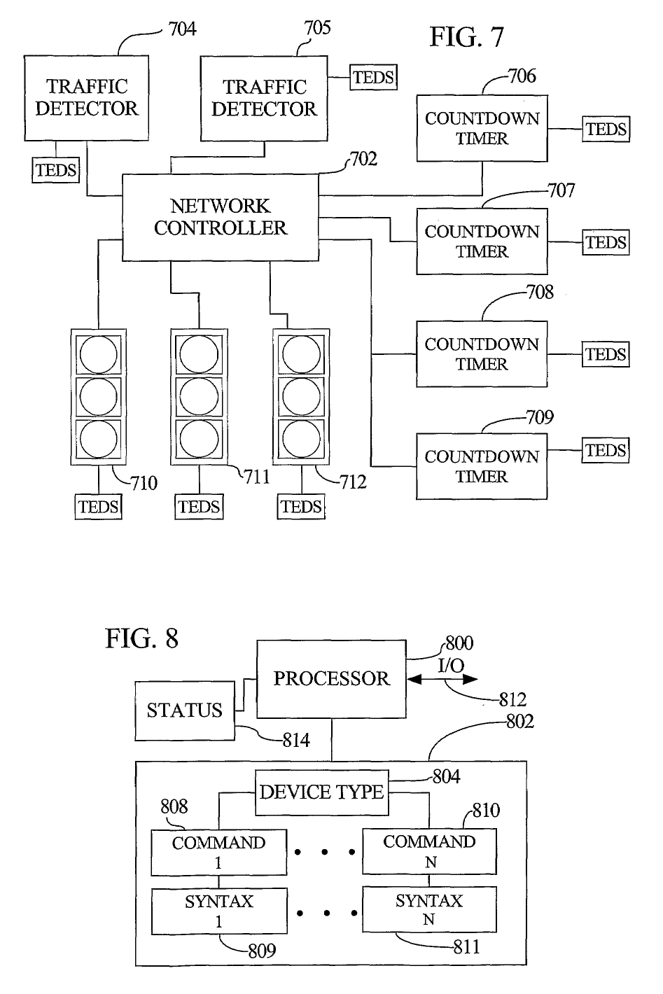

FIG. 7 illustrates a representative traffic control network that includes a controller 702, traffic detectors 704-705, countdown timers 706-709, and traffic signals 710-711. Additional traffic control devices such as additional traffic or pedestrian sensors or switches or other devices can be provided. As shown in FIG. 7, each of the devices has an associated TEDS stored in a respective memory. In some examples, one or more traffic control devices can be conventional devices lacking TEDS, and the controller 702 can be configured to communicate with these devices by a network technician. The devices can be in communication with the controller 702 via Ethernet or other connections using TCP/IP protocols or other communication protocols.

The controller 702 can be implemented as, for example, an Ethernet-enabled personal computer. Computer executable instructions for traffic control are stored on a disk, in memory, supplied via a local or wide area network, or otherwise provided. Typically the network is monitored to detect alerts from traffic devices that are newly installed, and traffic device status and control inputs upon installation. Representative messages include requests for STIM transducer descriptions, requests for STIM transducer channel data, and requests for an NCAP to report the operational status of a STIM. The controller 702 can also send instructions to set data values for any of the STIM channels. Messages that the controller can receive include STIM transducer descriptions, transducer data, and STIM status information. As shown in FIG. 6, selection boxes are provided to allow selection of data to send to any particular transducer channel. Based on a STIM description message, the controller enables selection boxes appropriate for the selected transducer. As noted previously, a traffic network is typically is configured to operate without user intervention, and the display of FIG. 6 is not needed.

Distributed traffic control devices can provide enhanced functionality. For example, vehicle quantity and type can be determined, and the traffic network controlled accordingly. Wireless communication with a visually impaired pedestrian can be used to provide feedback such as time remaining for safe crossing. Emergency vehicles can communicate a route to a traffic controller and receive priority only where it is needed. Traffic controllers can also communicate traffic flow and detour information to in-car navigation systems.

FIG. 8 is a block diagram of a representative traffic control device 800 that includes a processor that is in communication with a memory 802 that is configured to store a device type 804 and commands 808, 810 and the associated command parameter syntax and/or identifiers 809, 811 for communication to a network controller or other network device via an input/output port 812. The commands 808, 810 can be specific to the traffic control device 800 or can be based on standardized commands associated with devices of the particular device type. If device commands are standardized, an additional memory portion can be allocated to confirming which standard commands or sets of commands are available or unavailable. The traffic control device 800 can also include a memory 814 (or portion of some other memory) that is configured to store device status, such as current operating condition, time in operation, date/time of installation, device operational schedules, or other information. The input/output port can also provide operational data such a current state of signal lights or countdown timers, which can then be used to adjust or regulate other traffic control devices.

In a particular example, a pedestrian countdown timer can be configured to receive an indication of the duration of the interval during which the traffic signal displays a red ball (i.e., a stop signal). Based on this indication, the count-down timer adjusts the count-down display so that a pedestrian is aware of the actual time remaining in a walk cycle. Because countdown timers can be provided with actual signal durations, signal timings can be changed as needed in response to actual traffic, weather, or other conditions, without additional safety concerns for pedestrians. In contrast, conventional count-down timers have a fixed time interval, or require detection of an actual duration of a signal interval to establish the countdown display. Unfortunately, upon each traffic signal change, such a countdown timer must relearn an appropriate countdown time, and pedestrians can be left in mid-intersection at a signal change with a conventional count-down time still indicating that time is remaining.

Installation of a traffic control device such as that of FIG. 8 can be associated with communication of device status, device command data and syntax, or other device characteristics to a network controller or other network node. Generally, installation is associated with communication of device availability and device capabilities. However, in some examples, device capabilities can be stored and retrieved from a network location such as network controller or a traffic control device, or over a wide area network.

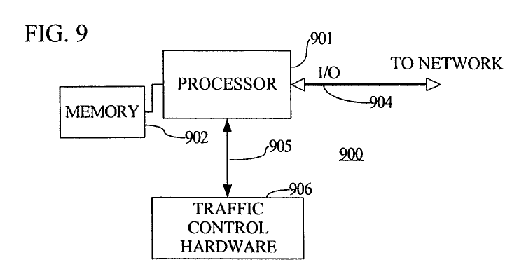

In a representative example illustrated in FIG. 9, a traffic control device 900 includes a processor 901 such as a microprocessor, a memory 902, and a bi-directional communication port 904 for connection to additional traffic control devices or a central traffic controller such as, for example, a traffic controller for an intersection. Bi-directional communication can be based on a variety of communication standards, including standards that provide error detection and control. The traffic control device 900 also includes traffic control hardware 906 such as a traffic or pedestrian sensor or signal that is coupled to the processor 901 via an internal bi-directional communication channel 905. The traffic control hardware 906 can include one or more sensors, traffic signals, or other traffic devices. Typical examples include traffic signals, vehicle detectors, pedestrian signals, and pedestrian count-down timers.

While the memory 902 can be configured to store an electronic data sheet for the traffic control device 900, the memory 902 can also be configured to store a sequence of computer-executable instructions associated with traffic control device operation and communication with other devices. For example, a processor executing such instructions can initiate traffic control device operational changes based on, for example, a time of day, road or traffic conditions, or an operational state of the traffic control device. These changes can be initiated with or without communication with other traffic control devices or a traffic network controller. For example, partial or complete equipment failure of the associated traffic control hardware 906 can be detected, and the traffic control hardware 906 reconfigured to establish a “safe-fail” condition in which traffic flow can continue safely, even if traffic flow is not optimally controlled.

Communications to and from other network devices (including an intersection controller) can be used to establish operating conditions. For example, if a traffic signal at a particular intersection becomes unavailable for communication, the remaining traffic control devices at the intersection can be adapted to permit safe traffic flow, even if the state of the unavailable traffic signal is unknown. While traffic signals can be automatically configured to display flashing red lights as a four way stop in case of failure, local or distributed intelligence permits additional safe-fail modes that are closer to normal intersection operations. In addition, road, traffic, or weather data can be received from other traffic devices or via a network, and traffic control device operation can be modified accordingly. For example, if possible freezing conditions are detected, then traffic light timings can be adjusted to allow for expected increases in stopping distance. When freezing conditions are no longer detected, the traffic control device can return to normal operation. In this way, the traffic control device 900 can dynamically adapt to changing conditions without requiring instructions from a central network controller. The traffic control device 900 can be configured to be responsive to local or distributed sensors such as temperature, precipitation, visibility, or emission sensors. Based on sensed conditions, phases of traffic signals or other traffic signal performance conditions at an intersection can be adjusted for safety.

For convenience, a traffic transducer is defined as a sensor or signal configured for use in a traffic control system. Typical sensors include loop detectors, motion detectors, cameras, radars, vehicle detectors and the like, as well as sensors for environmental conditions such as temperature and humidity, time and elapsed time, and other types of sensors and other devices that provide inputs such as pedestrian push buttons. Signals include signal lights, audible warning devices, count-down timers, and other devices.

In some examples, pedestrian call buttons can be associated with a visible or audible “button pressed” indication, so that a pedestrian can be confident that traffic signals will provide an interval for pedestrian crossing. Similar indications can be provided for vehicles as well and can be particularly convenient at intersections at which detection of a vehicle initiates a change in traffic signal status. Wireless buttons can be provided for vehicles or pedestrians, and can be configured to receive notifications acknowledging that a “button pressed” signal has been received. Traffic signal illumination levels (such as LED illumination levels) can be adjusted based on time of day, weather, or other conditions, and traffic control device response can be based on an identification of a service requestor. Thus, different vehicles and/or pedestrians can be given different priorities. Although devices with distributed intelligence provide these and additional features, such devices can also be configured to operate with legacy devices that lack such capabilities.

Representative traffic control systems, methods, and devices are described above. These are examples only, and are not to be taken as limiting the disclosed technology to any particular feature or combinations of features found in any example. In general, traffic control devices and systems are disclosed that permit bi-directional communication of multi-byte data including error detection and correction. A device can initiate unsolicited communications to other traffic controller devices in response to one or more inputs or based on an operation condition or status of the device. Electronic or other signals received by a traffic control device can be processed, and instructions or reports forwarded to other traffic control devices based on the processing. In addition, a traffic control device typically includes self-diagnostics and autonomous safe-fail operations in the event of a detectable system failure such as loss of communications or processor malfunction. A traffic control device can also process a plurality of input values, or a complex or continuous data stream associated with a plurality of measured or calculated values, and produce an associated series of output values or output value patterns. Traffic signal devices can also be associated with standard descriptions of device capability such as device operational and data characteristics, and instructions or information concerning remote access to such instructions or information.

In view of the many possible embodiments to which the principles of the disclosed technology may be applied, it should be recognized that the illustrated embodiments are only preferred examples and should not be taken as limiting the scope of the technology. Rather, the scope is defined by the following claims. We therefore claim all that comes within the scope and spirit of these claims.

We claim:

1. A traffic control device interface, comprising:
a memory configured to store a device definition; and
a processor configured to communicate at least a portion of the device definition to an interface output.

2. The traffic control interface device of claim 1, wherein the device definition includes a device description.

3. The traffic control interface device of claim 2, wherein the device definition is associated with available displays for a traffic signal.

4. The traffic control interface device of claim 3, wherein the available displays include at least two display patterns for at least one of a red, green, or yellow traffic signal color field.

5. The traffic control interface device of claim 2, wherein the device definition is associated with a duration of a count down interval for a pedestrian count down timer.

6. The traffic control interface device of claim 5, wherein the device definition is associated with an availability of an audible count down.

7. The traffic control interface device of claim 5, wherein the device definition is associated with count down time remaining for the pedestrian count down timer.

8. The traffic control interface device of claim 2, wherein the device definition is associated with a traffic count and a traffic count time interval for a traffic detector.

9. The traffic control interface device of claim 8, wherein the device definition is further associated with a vehicle type count.

10. An apparatus, comprising:
a memory configured to retain a traffic control device electronic definition;
an output configured to communicate at least a portion of the electronic definition; and
a traffic control device configured to process instructions based on the electronic definition.

11. The apparatus of claim 10, wherein the traffic control device is a traffic signal, and the electronic definition is associated with a plurality of display arrangements.

12. The apparatus of claim 10, wherein the traffic control device is a traffic signal having red, green, and yellow color fields, and the electronic definition is associated with display of a solid color or an arrow in a selected color field.

13. The apparatus of claim 10, wherein the traffic control device is a traffic detector, and the electronic definition is associated with activation of the traffic detector and a count of vehicles detected in a predetermined time period.

14. The apparatus of claim 10, wherein the traffic control device is a count down timer, and the electronic definition includes a count down period duration.

15. The apparatus of claim 14, wherein the electronic definition includes an indication of an audible alarm availability.

16. A traffic control system, comprising:
a plurality of traffic control devices;
a traffic system controller;
a network connecting the traffic control devices and the traffic system controller, wherein the traffic system controller and the traffic control devices are configured to exchange multi-bit traffic control parameters via the network.

17. The traffic control system of claim 16, wherein at least one of the traffic control devices and the traffic system controller are configured to communicate a count down timer duration via the network.

18. The traffic control system of claim 16, wherein the traffic controller is configured to transmit an instruction that is associated with display of a particular pattern in a selected traffic signal color field.

19. A traffic control method, comprising:
providing a plurality of traffic control devices; and
selecting an operational state of at least one traffic control device by communicating a multi-bit command to the at least one traffic control device.

20. The traffic control method of claim 19, further comprising:
interrogating at least one traffic control device to determine a current status; and
sending a traffic control device instruction to at least a second traffic control device based on the interrogation.

21. The traffic control method of claim 20, wherein the current status of the at least one traffic control device is an available time for crossing an intersection, and the traffic control device instruction is associated with a count down timer count duration.

22. A traffic signal, comprising red, green, and yellow color fields, wherein at least one of the color fields is configured to selectively display a solid circular color pattern and an arrow.

23. The traffic signal of claim 22, wherein each color field comprises a plurality of light emitters configured to form at least two display patterns.

24. The traffic signal of claim 23, further comprising an input configured to receive a control associated with selection of a particular display pattern.

25. A traffic control device, comprising:
a bi-directional communication port configured for communication over a traffic control network;
a traffic transducer; and
a processor coupled to the traffic transducer and to the bi-directional communication port.

26. The traffic control device of claim 25, wherein the traffic transducer is a signal device.

27. The traffic control device of claim 25, wherein the traffic transducer is a sensor device.

28. The traffic control device of claim 25, further comprising a memory configured to store a series of computer executable instructions for the processor.

29. The traffic control device of claim 25, wherein the processor is configured to establish a traffic transducer operating condition based on an input received via the bi-directional communication port.

30. The traffic control device of claim 25, wherein the processor is configured to establish a safe-fail operating condition for the traffic transducer in response to an absence of communication received on the bi-directional communication port.
